(19) United States
(12) Patent Application Publication
(10) Pub. No.: US 2025/0131528 A1
(43) Pub. Date: Apr. 24, 2025

(54) DYNAMIC RESIZING OF AUDIOVISUAL DATA

(71) Applicant: International Business Machines Corporation, Armonk, NY (US)

(72) Inventors: Subha Basu, HOWRAH (IN); Sourav Banerjee, Konnagar (IN); Sarbajit K. Rakshit, Kolkata (IN)

(21) Appl. No.: 18/490,796

(22) Filed: Oct. 20, 2023

(51) Int. Cl. G06T 3/40; G06V 10/26; G06V 10/774; G06V 10/82; G06V 10/94; H04N 5/262

(52) U.S. Cl. CPC G06T 3/4046; G06T 3/4053; G06V 10/273; G06V 10/82; G06V 10/945; H04N 5/2628; G06V 10/774

(57) ABSTRACT

Disclosed are techniques of a computer implemented method for resizing a captured image. One embodiment may comprise receiving a desired size and a subject of the captured image as input from a user, automatically resizing the captured image using a generative adversarial network (GAN) to about the desired size, where the resizing enhances a prominence of the subject of the captured as compared to the captured image, and storing the automatically resized image on a computer readable storage medium.

### BACKGROUND

The present disclosure relates to digital compression methods, and more specifically, to dynamic cropping, or otherwise resizing, images and/or video in accordance with user input.

The development of the EDVAC system in 1948 is often cited as the beginning of the computer era. Since that time, computer systems have evolved into extremely complicated devices. Today's computer systems typically include a combination of sophisticated hardware and software components, application programs, operating systems, processors, buses, memory, input/output devices, and so on. As advances in semiconductor processing and computer architecture push performance higher and higher, even more advanced computer software has evolved to take advantage of the relatively higher performance of those capabilities, resulting in computer systems today that are more powerful than just a few years ago.

These advances have caused network bandwidth and file storage size to become significant limiting factors in many systems. For example, an application (app) may ask users to upload a picture of their passport for verification purposes. However, the image captured by many users' smartphones may be of greater file size than the maximum size that can be uploaded in the app. While it is technically possible to use a lower resolution camera, such a solution may obscure critical detail that would be useable if captured at the higher resolution. In such a situation, the user has traditionally been asked to manually reduce the image size of the image (e.g., using a separate editing app) prior to uploading the requested image into the app. To continue the upload example, there may also be some sensitive information or unwanted surroundings captured in the image that are not required for the main purpose of the app. In this example, the user may further need to redact or blur parts(s) image so that the sensitive information is not exposed.

### SUMMARY

According to embodiments of the present disclosure, a computer implemented method for resizing a captured image, comprising receiving a desired size and a subject of the captured image as input from a user, automatically resizing the captured image using a generative adversarial network (GAN) to about the desired size, where the resizing enhances a prominence of the subject of the captured as compared to the captured image, and storing the automatically resized image on a computer readable storage medium.

A further aspect provides a corresponding computer program product.

A further aspect provides a system for implementing the above method.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates one embodiment of a data processing system (DPS), consistent with some embodiments.

FIG. 2 illustrates one embodiment of a cloud environment suitable for enabling a confidentiality-based intelligent task routing service mesh, consistent with some embodiments.

FIG. 3 shows a set of functional abstraction layers provided by a cloud computing environment, consistent with some embodiments.

FIG. 4 is an isometric view of an image capture device, such as a digital camera, consistent with some embodiments.

FIGS. 5A-5B are flow charts illustrating one method of identifying, by a digital capture device, which object(s) of the digital media file or potential digital media file can and/or cannot be desirably removed by a GAN-enabled aspect manager or by a GAN-enabled aspect manager executing on the image capture device, then dynamically resizing the image to reduce the size of the image, and thus, its resulting file size, consistent with some embodiments.

FIGS. 6A-6B are flow charts showing methods of performing the generation and discrimination operations, consistent with some embodiments.

FIG. 7A is an example block diagram of a generative adversarial network (GAN), consistent with some embodiments.

FIG. 7B illustrates an example AI model, consistent with some embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to digital compression methods; more particular aspects relate to dynamic cropping, or otherwise resizing, images and/or video in accordance with user input. While the present disclosure is not necessarily limited to such applications, various aspects of the disclosure may be appreciated through a discussion of various examples using this context.

A capture device may be any electronic device that can encode audiovisual data, such as still images (e.g., pictures), video, and/or audio (collectively audiovisual data or AV data). For example, the image capture device may be a standalone camera (e.g., a digital camera), a tablet, a smartphone, or a tablet computer capable of generating signals representing an image focused onto an integrated charge-coupled device (CCD). However, embodiments of the present disclosure are not limited to these examples. Thus, the terms “camera” and “capture device” may be used interchangeably herein.

Some capture device embodiments store the generated signals as encoded AV data in their local storage (i.e., within the device) and/or may transfer the captured audiovisual data to a remote server through a network. The generated signals may be encoded using one or more of a variety of encoding systems, including without limitation, Graphics Interchange Format (GIF), Joint Photographic Expert Group format (JPEG), Portable Network Graphics (PNG) format, and Advanced Video Coding (AVC, also referred to as H.264). Regardless of the specific encoding method used, the higher resolution at which the signals are encoded and/or reencoded, the more storage space and/or transfer time will be required. In some cases, the required storage may exceed the local storage of capture device. In other cases, higher-resolution media may exceed a desired amount of transfer time, e.g., due to bandwidth constraints. In other cases, the required storage may exceed one or more external constraints, such as imposed by a third party application (app).

Until now, a user's only options to address these constraints typically involved manually degrading the quality of the image, which had the undesirable side effect of also distorting the main subject of the image. In some applications, however, it may be beneficial to resize the image without distorting the main target or the subject matter of the image. Accordingly, some embodiments of this disclosure describe various methods for dynamic cropping, or otherwise resizing (i.e., changing the height and/or width), images and/or video in accordance with user input. Advantageously, the now-smaller image files (i.e., smaller “image size”) may be encoded and/or re-encoded into a smaller file size (i.e., “file size”) as a result of the cropping/resizing.

Some embodiments may leverage that, for a picture captured by a capture device, the resulting file size created from an image of a given image size will depend upon a number of different factors, including the resolution of the camera and surrounding on which the picture is taken. Accordingly, in some embodiments, a user may provide a desired file size input, and resizing may be done automatically by artificial intelligence e.g., in a smartphone or the like. In some embodiments, this may involve dynamically changing the aspect ratio of the images. In some embodiments, this may involve dynamically cropping less significant portions of the image. In some embodiments, the artificial intelligence may also automatically filter out any sensitive information (e.g., passport number, age, etc.) that was captured in the original picture.

In some embodiments, images to be captured by the capture device (or already captured by it) may be cropped/resized to satisfy user-input desired file size with help of one or more GANs (Generative Adversarial Networks). Generative modeling, in turn, generally refers to a type of unsupervised learning task that involves one or more artificial intelligence (AI) models that automatically discover and learn the regularities or patterns in input data in such a way that the AI model(s) can be used to generate new examples that plausibly could have been drawn from the original dataset. A GAN is a subtype of generative modeling in which two AI models compete with each other to become more accurate in their predictions. GANs typically run unsupervised and may use a cooperative zero-sum game framework.

The GAN in some embodiments may comprise a generator AI model (generator model) and a discriminator AI model (discriminator model). The output/objective of the generator model may be the creation of a fake output. The generator AI model may initially take random noise as input, and try to produce output similar to what would be produced by a real camera capturing real people and/or real places. The discriminator model, in turn, may act as an approver/rejector of the images produced by the generator model. The discriminator model may be trained with real images so that it has the ability to recognize real images. These real images may comprise images modified by users to achieve a desired/specified file size.

During a training stage, the real and the fake images (i.e., generated by a generator model) may be fed to the discriminator model. Initially, the discriminator model should not have a significant problem in distinguishing the real images from the generated images. The output from the discriminator, however, may be then used to further train the generator model. Guided by this feedback, the generator model modifies its approach, with the goal of producing a more authentic output in its next iteration. Over time, the generator model becomes better and better, and eventually it reaches an equilibrium in which the discriminator model can no longer reliably distinguish the generated (i.e., fake) images from the real images.

After the generator and discriminator models have been trained, the GAN may be used to examine images and, based upon a user-specified desired file size, automatically crop and/or resize the image to produce a smaller image size. Additionally, some or all of the surrounding items captured in the picture that are not the subject-of-interest may be treated as fake and may be automatically discarded by the discriminator model of the GAN. The discriminator model may also automatically redact and/or blur sensitive information in the image.

In some embodiments, the GAN may be part of a GAN-enabled aspect manager. The GAN-enabled aspect manager may be used to automatically crop/resize of a previously-captured image(s) based upon user input regarding desired file size and about the subject-of-interest of the image(s). Additionally or alternatively, some embodiments may discard the less significant portions of the image(s) and/or sensitive information in the image(s). In some embodiments, the resizing, cropping, and/or object deletions by be performed automatically by the GAN-enabled aspect manager pursuant to predetermined default settings established by the user.

In some embodiments, the user may have an option to input a desired file size and main subject of an image in textual, audio, and/or menu-based format, these inputs may be automatically may also translated into equivalent executable commands for processing. After receiving these inputs, the GAN-enabled aspect manager may automatically create a plurality of candidate images based on the original image having different heights/widths, etc. The candidate images may then be analyzed by the discriminator model. Some embodiments may define the main subject of the image as “real” in the discriminator model, and all other outputs generated from the surroundings of the image may be treated as “fake.” The discriminator model may automatically discard outputs that are not in line with the main subject matter of the image. In some embodiments, one of the candidate images may be selected such that the desired file size will be achieved, and the main subject made more prominent.

In some embodiments, during this operational stage, an image may be examined before or after capture, and, based upon the desired file size, may be automatically resized by the GAN-enabled aspect manager e.g., by having its aspect ratio changed. In these embodiments, the surrounding items captured in the picture that are not subject-of-interest may be treated as “fake” and may be discarded by the discriminator model. Additionally or alternatively, the image may be scrutinized at a macro level to detect any sensitive information that is not required in some embodiments. The identified sensitive information may also be treated as “fake” by the discriminator model and redacted/discarded.

In some embodiments, one or more objects in the captured images may be treated as input for the generator model. Using user input (e.g., of a desired size and main subject-of-interest), the subject-of-interest may be treated as “real” by the discriminator model and kept. Some or all of the other objects may be treated as “fake” by the discriminator model and discarded. That is, at the discriminator model, the subject-of-interest for the intended image may be treated as “real,” and all other outputs generated from the surroundings of the image may be treated as “fake.” In this way, the discriminator model may automatically discard media contents that are not in line with the desired context of usage, the intend of usage, the subject-of-interest, desired final size, etc. In some embodiments, the discriminator model may further scrutinize the image at the macro level to detect any sensitive information (and which is not required for the application) and will also treat that information as “fake” info, to be discarded as “fake.”

In some embodiments, the GAN-enabled aspect manager may further comprise a Super Resolution GAN (SRGAN), which may be used to enhance the main subject-of-interest (e.g., by capturing additional exposures of the subject-of-interest for high-dynamic range imaging or by generating a photorealistic high-resolution image of the subject-of-interest from other photographs) if the output of the GAN-enabled aspect manager is less than the specified image size limit. In this way, the quality of the main subject-of-interest is maximized within the constraint of the specified file size limit.

Additionally or alternatively, some embodiments may, based on comparative analysis between the context of the usage and content of the media contents, the GAN-enabled aspect manager may identify selective enhancements, blurring, resizing, repositioning (with 3D space, like depth and positions, etc.) of various objects within the media content so that desired file size optimal of the AV content is achieved with the GAN-enabled aspect manager. For example, based on any available dimension where any media content is to be adapted (e.g., a TV display, online form update, etc.), the GAN-enabled aspect manager may consider a user's level of comfort, choice of watching, and accordingly based on the context of the media, invention may the selecting an appropriate aspect ratio of the media, and accordingly using the GAN, adapt the media content to the identified aspect ratio.

One feature and advantage of some embodiments is that a GAN-enabled aspect manager may automatically resize, crop, change the aspect ratio of, and/or otherwise reduce the image size of so that the resulting file size is at or below a user-specified size, without minimal impact on image quality of the main subject-of-interest. This, in turn, may help preserve usefulness of the image for the underlying application, as the clarity of the main subject-of-interest in captured photographs (images) and/or video is often the most desirable criteria for subsequent processing.

Another feature and advantage of some embodiments is GAN-enabled consolation via visual objection recognition. In these embodiments, while capturing media content (e.g., photograph or video), the GAN-enabled aspect manager may recognize a plurality of objects to be captured by the capture device, and then may determine which of those object(s) comprise the identified main subject. Based on this determination, some embodiments may automatically crop, adjust the image size (e.g., reduce the height and width of the image) such that the resulting media content storage file can be kept under a predetermined maximum file size. Some embodiments may further repeat these operations as needed to maintain the desired total storage size for a collection of images.

Another feature and advantage of some embodiments is available storage and/or bandwidth transfer validation. The GAN-enabled aspect manager in these embodiments may initially determine an amount of available storage in the local device to store the media, a current amount of network bandwidth available (e.g., if the media content is transferred through network), and/or a current amount of storage available on a remote digital media storage system. Based on these determination(s), the GAN-enabled aspect manager may dynamically determine whether or not the GAN-enabled aspect manager is to be enabled, as well as an amount of media content to be dynamically cropped/removed, for optimum capture of the media contents with any determined size and/or bandwidth constraints.

Another feature and advantage of some embodiments is GAN-enabled decision processing for capturing requirements. In some embodiments, if the capture device needs additional storage space to store new videos and/or images, then the GAN-enabled aspect manager may automatically perform an analysis of the existing stored media contents (e.g., previously captured images and/or video) and may automatically crop, resize, and/or adjust the aspect ratio those already-captured media files to reduce the respective image size(s), and thus, to free additional storage space. In this way, these embodiments may automatically enable creation of additional storage space on the local or remote storage. Additionally, the storage space may be dynamically re-optimized through time e.g., a picture may be analyzed and stored at a first image/file size, then later reanalyzed and stored at a smaller image/file size. In some embodiments, this automatic process may also be performed in response to a user indicating that he or she wishes to free up storage space on the capture device for future use.

Another feature and advantage of some embodiments is automatic redaction of sensitive information from images. Based at least in part on a historical evaluation the uses of images in applications and/or in a particular application/website currently being interacted with on the capture device, the GAN-enabled aspect manager in these embodiments may automatically (based on user settings) identify which object(s) in the photo and/or video should be removed to protect the user's personal information and which object(s) should remain to satisfy the application's primary purpose. The GAN-enabled aspect manager may also automatically crop, blur, or otherwise distort those object(s) that should be removed based at least in part on the identification.

Another feature and advantage of some embodiments is the use of the GAN-enabled aspect manager to resize AV content, while optimizing for the context of usage and the main subject of the content. These embodiments may, at a generator model of a GAN, generate various resized versions of the input media content based on the context of usage. A discriminator model may evaluate the outputs and selects only those that align with the intended usage and subject of the media. These embodiments may also utilize the GAN-enabled aspect manager for selective enhancements, blurring, resizing, and repositioning of objects within the media content to achieve the desired final size. The changes may be selected based on the user-provided level of comfort score and/or a user-provided context in which the media will be used.

Another feature and advantage of some embodiments is the use of a GAN-enabled aspect manager to resize AV content, select the most appropriate image size to maintain the context of the media based on the context of usage of the media or provided aspect ratio by the user. Some embodiments may analyze a usage need of any media content by analyzing user-provided information (e.g., a requested file size and main subject of the image) in textual or audio/voice input and/or the content of other apps in which the media will be used (e.g., a specific application, website, etc.) Some embodiments may further analyze using metadata provided by the capture device (e.g., a current location) and/or metadata provided by another application executing on the capture device (e.g., maximum upload size for that app). The GAN-enabled aspect manage may use this information to generate appropriate one or more candidates with different image sizes/aspect ratios of the input media content to produce the required file size. The GAN-enabled aspect manager may automatically select from among these candidates using one or more predetermined quality metrics, or may prompt the user to select a preferred final image. This selection may be performed using a third AI model trained using user feedback on previous GAN-enabled aspect manager outputs in some embodiments.

Another feature and advantage of some embodiments is that the GAN-enabled aspect manager may change the aspect ratio of the image to make the main subject-of-interest more prominent, consistent with the additional user input. Additionally or alternatively, the GAN-enabled aspect manager may refine refinement the image by filtering out objects that are not required (thereby further making the main subject-of-interest more prominent), again in accordance with the desired final size.

Another feature and advantage of some embodiments is that they may not require a pre-defined image size or aspect ratio as input. Instead, these embodiments may take functional inputs e.g., the desired final file size of the image, the desired main subject of the image, etc. Based upon these inputs, some embodiments may filter or otherwise remove surrounding objects to make the main subject more prominent e.g., remove objects that do not overlap with the main subject-of-interest, such that substantially only the subject-of-interest of the image remains. In this way, these embodiments ensure that they present a prominent image of the subject-of-interest.

Another feature and advantage of some embodiments is that the user may provide desired image size and subject-of-interest of the image. Based on that input, the generator model of the GAN-enabled aspect manager may create and add “fake” results to the image e.g., additional noise inputs, additional surroundings, additional background objects, etc. The discriminator model of the GAN-enabled aspect manager may filter out those additions to update the size of the image. That is, the discriminator model may be filter the generated fakes that are derived from the surroundings other than main subject of the image.

### Data Processing System (DPS)

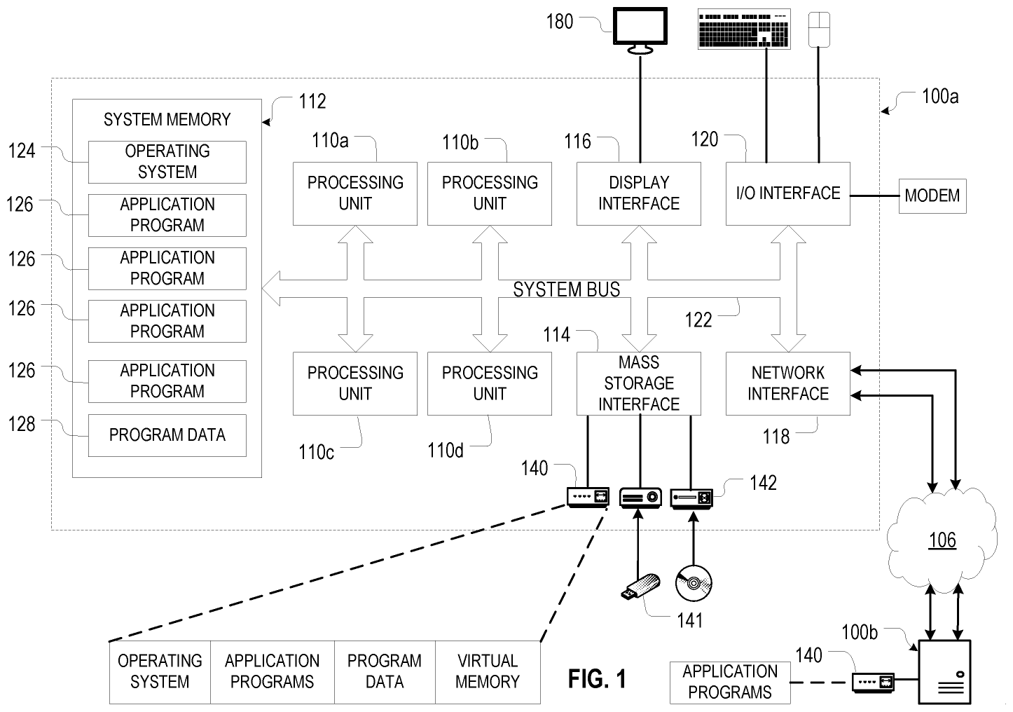

FIG. 1 illustrates one embodiment of a data processing system (DPS) 100a, 100b (herein generically referred to as a DPS 100), consistent with some embodiments. FIG. 1 only depicts the representative major components of the DPS 100, and those individual components may have greater complexity than represented in FIG. 1. In some embodiments, the DPS 100 may be implemented as a personal computer; server computer; portable computer, such as a laptop or notebook computer, PDA (Personal Digital Assistant), tablet computer, or smartphone; processors embedded into larger devices, such as an automobile, airplane, teleconferencing system, appliance; smart devices; or any other appropriate type of electronic device. Moreover, components other than or in addition to those shown in FIG. 1 may be present, and the number, type, and configuration of such components may vary.

The DPS 100 in FIG. 1 may comprise a plurality of processing units 110a-110d (generically, processor 110 or CPU 110) that may be connected to a main memory 112, a mass storage interface 114, a terminal/display interface 116, a network interface 118, and an input/output (“I/O”) interface 120 by a system bus 122. The mass storage interface 114 in this embodiment may connect the system bus 122 to one or more mass storage devices, such as a direct access storage device 140, a USB drive 141, and/or a readable/writable optical disk drive 142. The network interface 118 may allow the DPS 100a to communicate with other DPS 100b over a network 106. The main memory 112 may contain an operating system 124, a plurality of application programs 126, and program data 128.

The DPS 100 embodiment in FIG. 1 may be a general-purpose computing device. In these embodiments, the processors 110 may be any device capable of executing program instructions stored in the main memory 112, and may themselves be constructed from one or more microprocessors and/or integrated circuits. In some embodiments, the DPS 100 may contain multiple processors and/or processing cores, as is typical of larger, more capable computer systems; however, in other embodiments, the DPS 100 may only comprise a single processor system and/or a single processor designed to emulate a multiprocessor system. Further, the processor(s) 110 may be implemented using a number of heterogeneous data processing systems in which a main processor 110 is present with secondary processors on a single chip. As another illustrative example, the processor(s) 110 may be a symmetric multiprocessor system containing multiple processors 110 of the same type.

When the DPS 100 starts up, the associated processor(s) 110 may initially execute program instructions that make up the operating system 124. The operating system 124, in turn, may manage the physical and logical resources of the DPS 100. These resources may include the main memory 112, the mass storage interface 114, the terminal/display interface 116, the network interface 118, and the system bus 122. As with the processor(s) 110, some DPS 100 embodiments may utilize multiple system interfaces 114, 116, 118, 120, and buses 122, which in turn, may each include their own separate, fully programmed microprocessors.

Instructions for the operating system 124 and/or application programs 126 (generically, “program code,” “computer usable program code,” or “computer readable program code”) may be initially located in the mass storage devices, which are in communication with the processor(s) 110 through the system bus 122. The program code in the different embodiments may be embodied on different physical or tangible computer-readable media, such as the memory 112 or the mass storage devices. In the illustrative example in FIG. 1, the instructions may be stored in a functional form of persistent storage on the direct access storage device 140. These instructions may then be loaded into the main memory 112 for execution by the processor(s) 110. However, the program code may also be located in a functional form on the computer-readable media, such as the direct access storage device 140 or the readable/writable optical disk drive 142, that is selectively removable in some embodiments. It may be loaded onto or transferred to the DPS 100 for execution by the processor(s) 110.

With continuing reference to FIG. 1, the system bus 122 may be any device that facilitates communication between and among the processor(s) 110; the main memory 112; and the interface(s) 114, 116, 118, 120. Moreover, although the system bus 122 in this embodiment is a relatively simple, single bus structure that provides a direct communication path among the system bus 122, other bus structures are consistent with the present disclosure, including without limitation, point-to-point links in hierarchical, star or web configurations, multiple hierarchical buses, parallel and redundant paths, etc.

The main memory 112 and the mass storage device(s) 140 may work cooperatively to store the operating system 124, the application programs 126, and the program data 128. In some embodiments, the main memory 112 may be a random-access semiconductor memory device (“RAM”) capable of storing data and program instructions. Although FIG. 1 conceptually depicts the main memory 112 as a single monolithic entity, the main memory 112 in some embodiments may be a more complex arrangement, such as a hierarchy of caches and other memory devices. For example, the main memory 112 may exist in multiple levels of caches, and these caches may be further divided by function, such that one cache holds instructions while another cache holds non-instruction data that is used by the processor(s) 110. The main memory 112 may be further distributed and associated with a different processor(s) 110 or sets of the processor(s) 110, as is known in any of various so-called non-uniform memory access (NUMA) computer architectures. Moreover, some embodiments may utilize virtual addressing mechanisms that allow the DPS 100 to behave as if it has access to a large, single storage entity instead of access to multiple, smaller storage entities (such as the main memory 112 and the mass storage device 140).

Although the operating system 124, the application programs 126, and the program data 128 are illustrated in FIG. 1 as being contained within the main memory 112 of DPS 100a, some or all of them may be physically located on a different computer system (e.g., DPS 100b) and may be accessed remotely, e.g., via the network 106, in some embodiments. Moreover, the operating system 124, the application programs 126, and the program data 128 are not necessarily all completely contained in the same physical DPS 100a at the same time, and may even reside in the physical or virtual memory of other DPS 100b.

The system interfaces 114, 116, 118, 120 in some embodiments may support communication with a variety of storage and I/O devices. The mass storage interface 114 may support the attachment of one or more mass storage devices 140, which may include rotating magnetic disk drive storage devices, solid-state storage devices (SSD) that uses integrated circuit assemblies as memory to store data persistently, typically using flash memory or a combination of the two. Additionally, the mass storage devices 140 may also comprise other devices and assemblies, including arrays of disk drives configured to appear as a single large storage device to a host (commonly called RAID arrays) and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), holography storage systems, blue laser disks, IBM Millipede devices, and the like. The I/O interface 120 may support attachment of one or more I/O devices, such as a keyboard, mouse, modem, or printer (not shown).

The terminal/display interface 116 may be used to directly connect one or more displays 180 to the DPS 100. These displays 180 may be non-intelligent (i.e., dumb) terminals, such as an LED monitor, or may themselves be fully programmable workstations that allow IT administrators and users to communicate with the DPS 100. Note, however, that while the display interface 116 may be provided to support communication with one or more displays 180, the DPS 100 does not necessarily require a display 180 because all needed interaction with users and other processes may occur via the network 106.

The network 106 may be any suitable network or combination of networks and may support any appropriate protocol suitable for communication of data and/or code to/from multiple DPS 100. Accordingly, the network interfaces 118 may be any device that facilitates such communication, regardless of whether the network connection is made using present-day analog and/or digital techniques or via some networking mechanism of the future. Suitable networks 106 include, but are not limited to, networks implemented using one or more of the “InfiniBand” or IEEE (Institute of Electrical and Electronics Engineers) 802.3x “Ethernet” specifications; cellular transmission networks; wireless networks implemented one of the IEEE 802.11x, IEEE 802.16, General Packet Radio Service (“GPRS”), FRS (Family Radio Service), or Bluetooth specifications; Ultra-Wide Band (“UWB”) technology, such as that described in FCC 02-48; or the like. Those skilled in the art will appreciate that many different network and transport protocols may be used to implement the network 106. The Transmission Control Protocol/Internet Protocol (“TCP/IP”) suite contains a suitable network and transport protocols.

### Cloud Computing

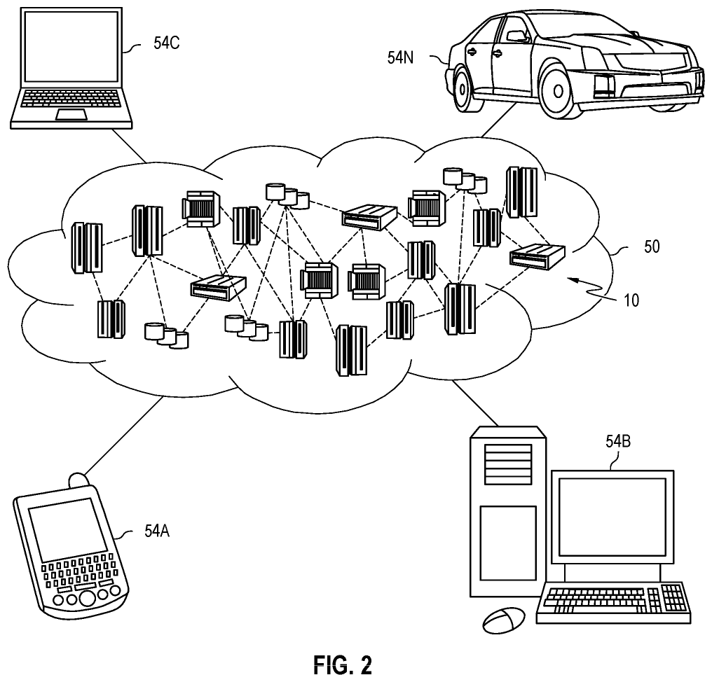

FIG. 2 illustrates one embodiment of a cloud environment suitable for enabling a digital media storage system using one or more DPS, such as DPS 100. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

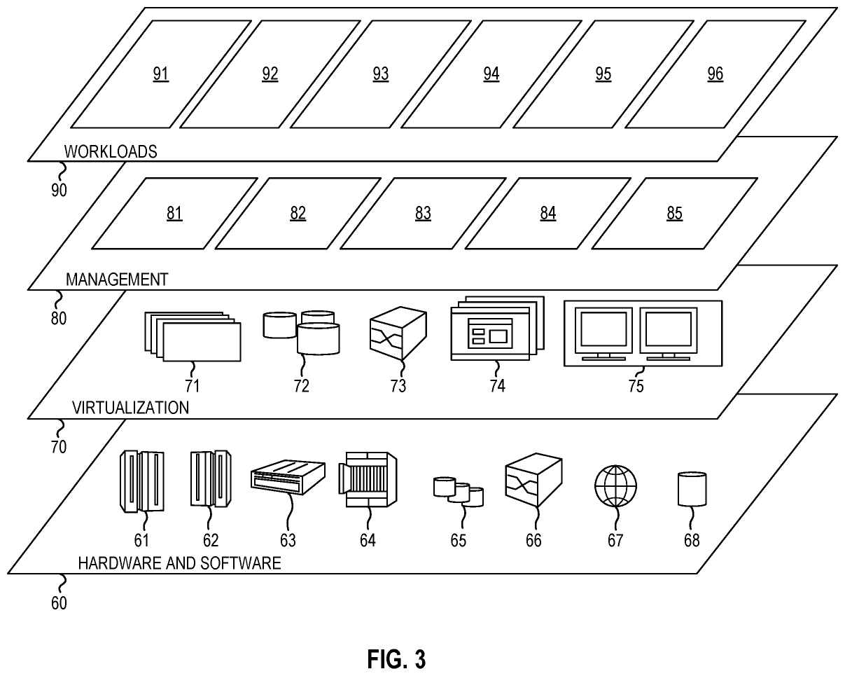

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; text to speech processing service 93; data analytics processing 94; transaction processing 95; and GAN-enabled aspect manager 96. The GAN-enabled aspect manager 96, in turn, may comprise a generator model and a discriminator model (not shown).

Workloads layer 90 provides examples of functionality for which the cloud computing environment may be utilized. Examples of workloads and functions which may be provided from this layer include: mapping and navigation 91; software development and lifecycle management 92; text to speech processing service 93; data analytics processing 94; transaction processing 95; and GAN-enabled aspect manager 96. The GAN-enabled aspect manager 96, in turn, may comprise a generator model and a discriminator model (not shown).

### Digital Capture Device

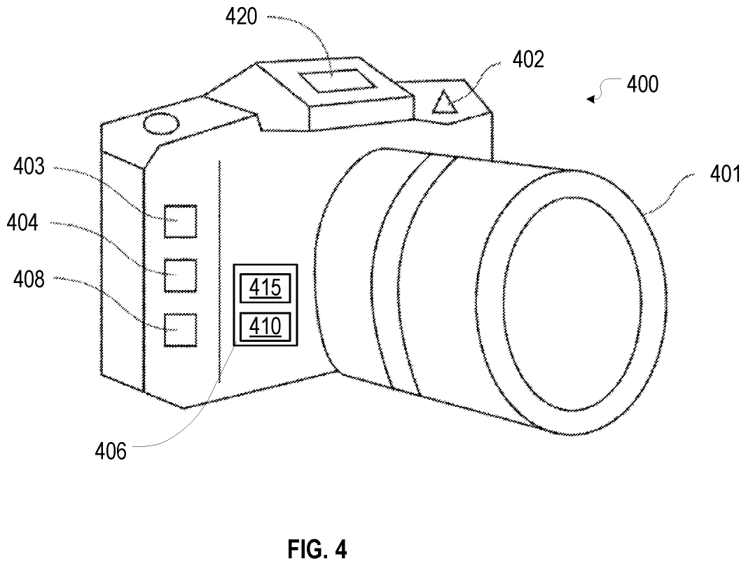

FIG. 4 is an isometric view of an image capture device 400, such as a digital camera, consistent with some embodiments. This image capture device 400 may include a camera lens 401, an image sensor 402 (e.g., a charge coupled device), a microphone 403, a wireless network interface 404 configured to establish a network (e.g., Internet) connection with the digital media storage system of FIG. 2, a memory 406, and a processor 408. The memory 406, in turn, may store an image capture program 410 and image data 415 associated with one or more captured images and/or videos. The processor 408 may execute the image capture program 410 in response to user input.

In operation, a user may direct the image capture device 400 to capture a particular scene containing a plurality of objects. The image capture program 410 may respond by causing the camera lens 401 to focus the scene onto the image sensor 402. Simultaneously, the image capture program 410 may cause the microphone 403 to capture sounds associated with the scene. The image sensor 402 and the microphone 403 may create electrical signal(s) representing the image, video, and/or sound, which may then be encoded into a digital media file. That digital media file, in turn, may be transmitted to the digital media storage system of FIG. 2 using the wireless network interface 404, may be stored in the memory 406, or both.

In some embodiments, the image capture device 400 may further include a user interface 420. The user interface 420 may include one or more interface screens, such as a touch screen for receiving input from the user and/or displaying image capture device information to a user. The user may interact with the user interface 420 to modify the camera's settings or to respond to a prompt by the image capture device 400. For example, the image capture device 400 may pose a query to the user regarding a number of images that will be taken during an event and for what purposes those images will be used, and the user's response may be used by the image capture device 400 when capturing images in the future, as discussed below in more detail.

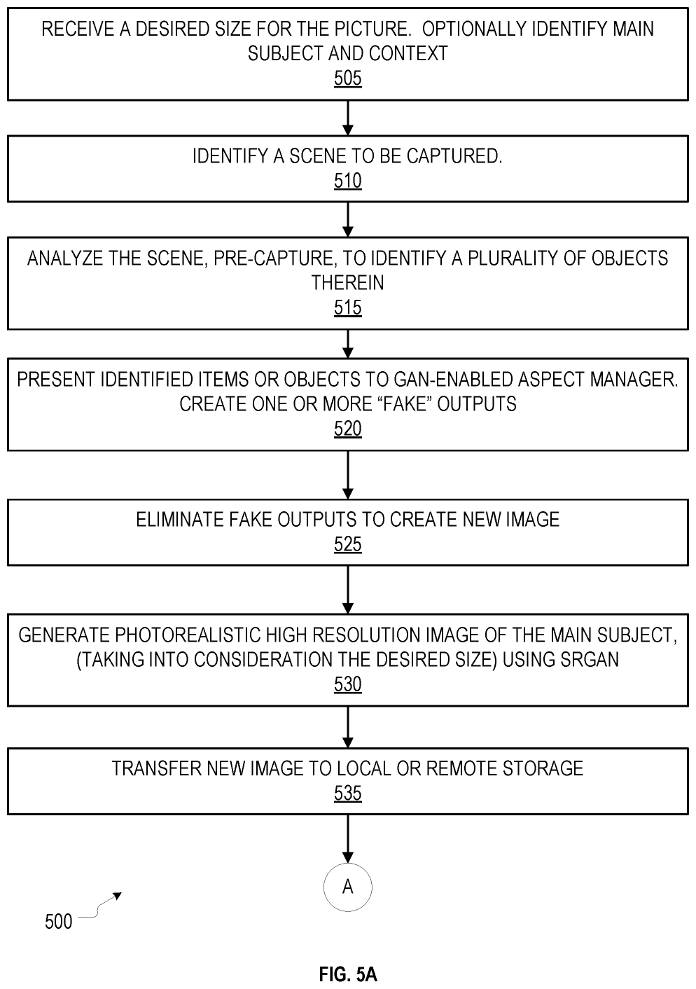

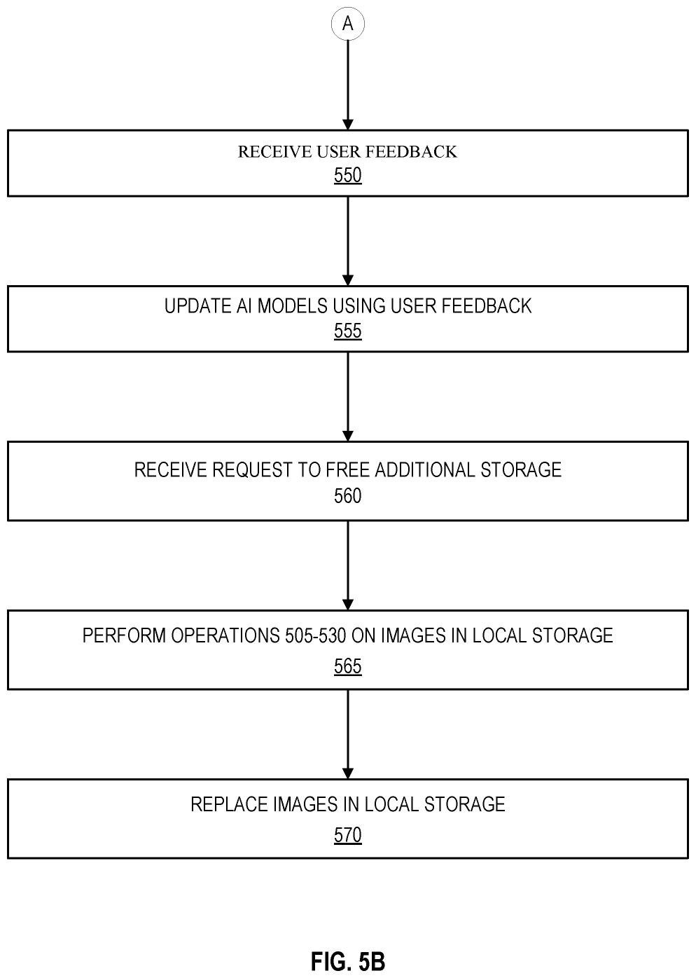

FIGS. 5A-5B are flow charts illustrating one method 500 of identifying, by the digital capture device 400, which object(s) of the digital media file or potential digital media file can and/or cannot be desirably removed by the GAN-enabled aspect manager 96 or by a GAN-enabled aspect manager executing on the image capture device 400, then dynamically resizing the image to reduce the size of the image, and thus, its resulting file size, consistent with some embodiments. The method of FIGS. 5A-5B will be described with reference to an example usage scenario. In this example usage scenario, a user may be required to upload the picture of their passport for verification purposes into an application (app). Unfortunately, a picture taken by the user's smartphone will be of greater size than allowed by the app (e.g., greater than the max size that can be uploaded in the app). Accordingly, to achieve their goal in the application, the user would need to reduce the size of the image. In this example, the user allows the GAN-enabled aspect manager to automatically resize the image by changing its image size to achieve the desired maximum file size. Additionally, the passport may contain sensitive information or unwanted surroundings captured in the image, which are not required for the main purpose of passport image. Thus, the user may also desire blur, or otherwise redact, portions of the image containing that sensitive information. In this example, the user will also allow the GAN-enabled aspect manager to automatically identify and discard the sensitive portions of the image e.g., by treating those portions of the image as “fake” parts and discarding them.

In this example, the user initially inputs the desired final file size of the image and a main subject-of-interest of the image via voice input. In response to that input, the GAN-enabled aspect manager may automatically convert the commend into a text command using a text-to-speech service, such text to speech processing service 93 of cloud computing environment 50.

In operation, the input desired file size, the input main subject-of-interest for the image, and the surroundings of that main subject-of-interest may all be treated as individual inputs to the GAN-enabled aspect manager. From these inputs, trained generator and discriminator models may be applied to create a plurality of candidate output images. In the example above, assume the image of the passport also includes part of a table. In this example, the discriminator model may identify the passport image as the main subject-of-interest of the image and treat it as the “real” output. The discriminator model in some embodiments may also identify everything else, such as the table, as “fake” outputs. The “fake” outputs may then be removed from the image.

To decrease the total size of the image, the generator model may generate one or more temporary fake objects and temporarily add them to the picture. Then, at the discriminator model, the subject-of-interest will be detected as “real”, and will be made more prominent by removing those temporary fake objects. If the resulting file size is over the input file size, this process may be repeated. If the resulting file size is less than the input file size, or if the main subject of the image is lacking in quality on some predetermined metric, a Super Resolution GAN (SRGAN) may be used to generate photorealistic high resolution image of the main subject-of-interest using e.g., other images of the main subject-of-interest. This generated image may replace the actual subject-of-interest in the image.

While the passport photo example is provided herein for clarity, this disclosure is not limited to such photographs, or even to still images. For example, in some embodiments, if a user is watching a media content in any TV and the user wants to change the aspect ratio of the media content e.g., because of display of additional media content along with the desired content, embodiments of the GAN-enabled aspect manager may be used to change the aspect ratio of each fame of the media.

Turning now to FIG. 5A, at operation 505, the user of the digital capture device 400 may provide a desired file size for an image to be captured or for an already captured image. Optionally, the user may also input some context about the image, such as whether the main subject of the image is a passport photo, some landscape, a background picture, etc. The capture device may also use other available metadata, such as a current time and location or other apps open on the capture device. At operation 510, the digital capture device 400 may identify a scene to be captured. This may include receiving input from a user/operator about an exact direction, angle, timing, shutter speed, etc., at which the digital capture device 400 should operate. At operations 515-520, the digital capture device 400 generates a capture plan for the scene. This may include analyzing the scene, pre-capture, to identify a plurality of objects therein at operation 515, and then automatically determining which of those objects is the primary subject-of-interest. Operation 515 may be performed using a conditional GANs (CGANs). A CGAN, in turn, generally refers to a type of GAN that involves the conditional generation of images by a generator model. Image generation can be conditional on a class label, if available, allowing the targeted generated of images of a given type. Also at operation 515, if the user input context at operation 505, that context may be treated as an extra level of information by the CGAN. These inputs may be used be in discriminator model (described below) to generate new versions of the image in which the main subject is more prominent than in the original image e.g., the main subject consumes a larger percentage of pixels in the resulting image, is more centered inside the image, etc.

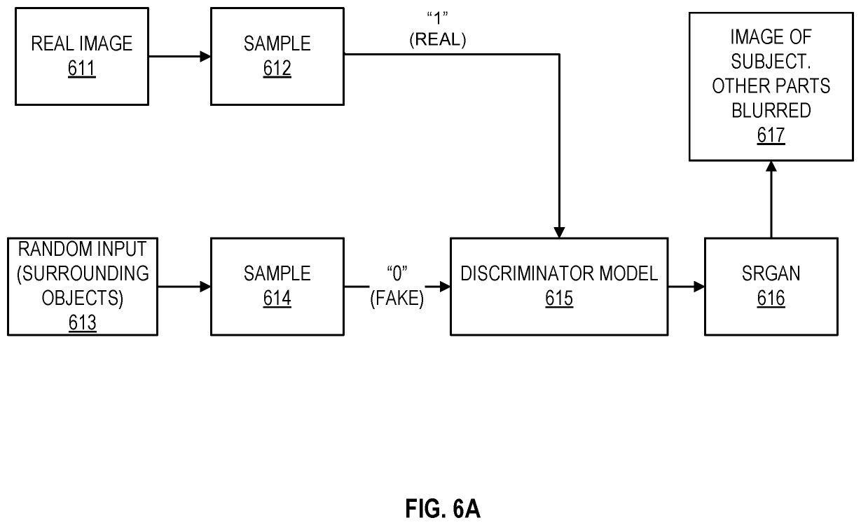

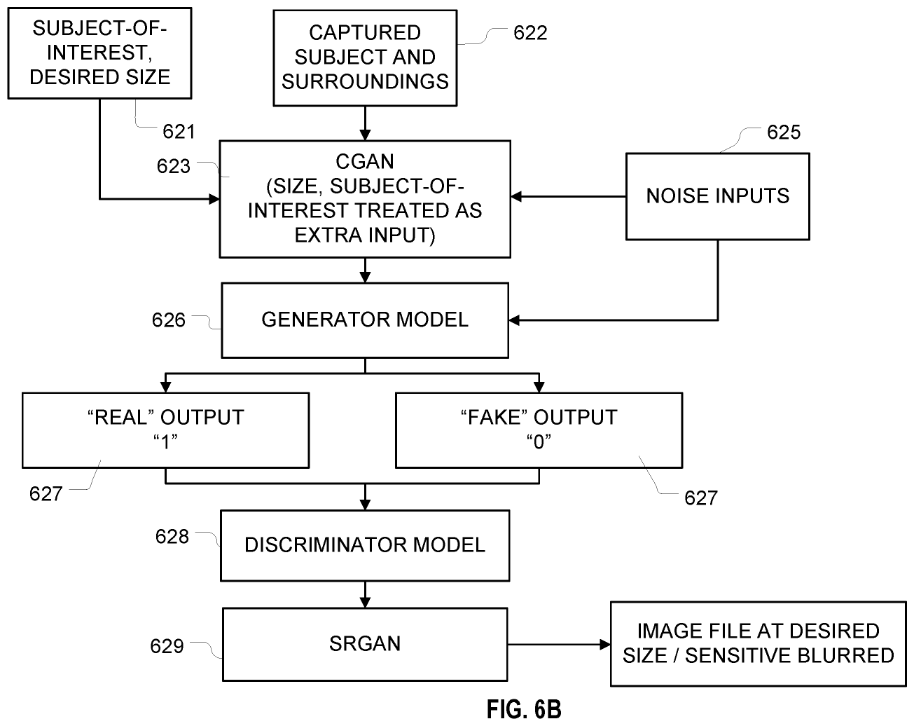

At operation 520, the identified items/objects in the image will be presented as inputs to the GAN-enabled aspect manager 96, and the other items/objects (e.g., surroundings) will be presented as noise inputs. Based upon the identified main subject of the picture, the generator model in GAN-enabled aspect manager 96 may use all the surrounding objects as samples and may create one or more outputs that will be treated as “fake” in the discriminator model. In some embodiments, the “fake” outputs may be treated as 0 in output and to be used in the discriminator level as in FIGS. 6A and 6B.

At operation 525, when discriminator model of the GAN-enabled aspect manager 96 identifies the fake objects from the image, like the surrounding objects that are not required. At operation 530, the GAN-enabled aspect manager 96 create a new image by removing the identified “fake” portions of the original image. This alter the heights, width, and/or aspect ratio of the image to achieve the desired file size. This may also make the main subject of the image more prominent and/or to remove/blur objects detected as fake (e.g., sensitive information). Next, at operation 530, the SRGAN may be used to generate a photorealistic high resolution image of the main subject taking into consideration the desired file size of the image. The SRGAN, in turn, may comprise a generative adversarial network trained to generate high resolution images from low resolution images using perceptual loss function that is made of the adversarial loss as well as the content loss. The generated main subject may replace the main subject in the image. At operation 535, the resulting image may be encoded/reencoded, and then transferred to remote storage over the network. Additionally or alternatively, this operation 530 may include storing the digital information locally in memory 406.

At operation 550, the user may be asked for feedback on whether the generated image size and/or aspect ratio was altered in a subjectively desirable manner, made the main subject more prominent, correctly blurred or redacted the sensitive information, and/or whether any desirable objects where incorrectly removed. At operation 555, this user feedback may be used to further train the discriminator model of the GAN-enabled aspect manager 96. In some embodiments, this additional training may be used to personalize the GAN-enabled aspect manager 96 for a particular user. In other embodiments, this additional training may be collected from many users and used to improve the discriminator model for all users.

At operation 560, the user may indicate that he or she wishes to increase the amount of available storage space on a local storage device e.g., to allow capture of additional images. In response, the digital capture device 400 may perform a storage assessment at operation 555. This may include identifying the available local storage in which the captured images may be stored. This may also include identifying available remote storage where the captured data is to be stored. At operation 565, the digital capture device 400 may perform operations 505-530 on one or more images in the local storage. At operation 570, the digital capture device 400 may replace the original image files with the altered image files. At operation 575, the digital capture device 400 may track data usage and storage space, and/or time required on an ongoing basis. For example, if the digital capture device 400 determines that the amount of local or remote storage is low (e.g., below a threshold value), then the digital capture device 400 may automatically perform the operations 515-540 again on one or more images in the local storage.

FIGS. 6A-6B are flow charts showing methods of performing the generation and discrimination operations, based upon user inputs such as main subject matter of the image, desired file size, and the like, as well as how GAN model may filter out noise from picture as fake (0), consistent with some embodiments. More specifically, FIG. 6A is a flow chart showing one method of training a discriminator model of a GAN-enabled aspect manager 96, consistent with some embodiments. At block 611-612, an original image file is sampled and passed to a discriminator model of the GAN-enabled aspect manager 96. At block 613, the generator model of the GAN-enabled aspect manager 96 will generate random input and add it to the original image file. This enhanced image is sampled at operation 614 and then passed to discriminator model of the GAN-enabled aspect manager 96. At operation 615, the discriminator model of the GAN-enabled aspect manager 96 attempts to predict whether each part/object in the two images are “real” (binary true) or “fake” false. At operation 616, the real portion(s) of the two images are collected into a new image file, and the fake portions are deleted or blurred. Also at operation 616, the new image file may be optionally passed to the SRGAN to improve the image quality of the resulting file. At operation 617, the output image may be compared to the original image, e.g., by a human evaluator, to determine if the discriminator model correctly identified the main subject and/or the sensitive information. At operation 618, the evaluation may be used to further tune and/or retune the operation of the discriminator model.

FIG. 6B is a method of operating a GAN-enabled aspect manager 96, consistent with some embodiments. At optional operation 621, a user may also input context about the image, such as whether the main subject of the image is a passport photo, some landscape, a background picture, etc. At operation 622, a digital file (or current output from image sensor 402 of capture device 400) may be received. At operation 623, a cGAN may evaluate the digital file or current output to identify one or more objects in the image. If user input was received at operation 621, that information may be treated as an extra level of information in operation 623. The cGAN may also generate one or more noise inputs 625, such as a tree, table, or furniture surrounding the main subject.

Next, at operation 626, the generator model of the GAN-enabled aspect manager 96 may combine the generated noise with the image to create a fake image output 627. The fake image output 627 and the original image may be passed 628 to the discriminator model of the GAN-enabled aspect manager 96, which may analyze the images, treating the added material as ‘fake’ and the main subject as ‘real.’ Also at operation 627, the discriminator may remove the fake portions from the image, leaving the main subject with the fake portions removed/blurred. At operation 629, the output from the discriminator model may be optionally passed to a SRGAN to improve the overall image quality to the desired resolutions.

### Machine Learning

As previously discussed, generative machine learning models may be used to for dynamic resizing of audiovisual data. Generative adversarial networks (GANs) may utilize two neural networks referred to as a discriminator AI model and a generator AI model, respectively, which may operate in a minimax game to find the Nash equilibrium. That is, the generator AI model may seek to create as many realistic images as possible and the discriminator AI model may seek to distinguish between images that are real and generated (fake) images.

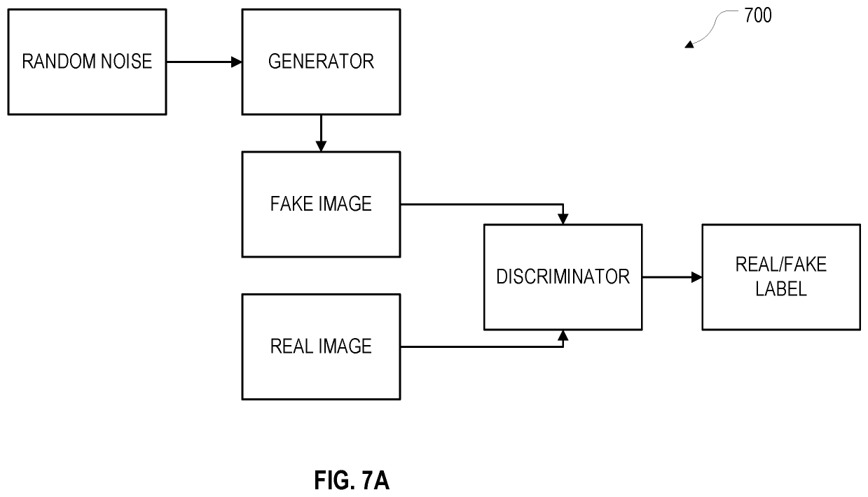

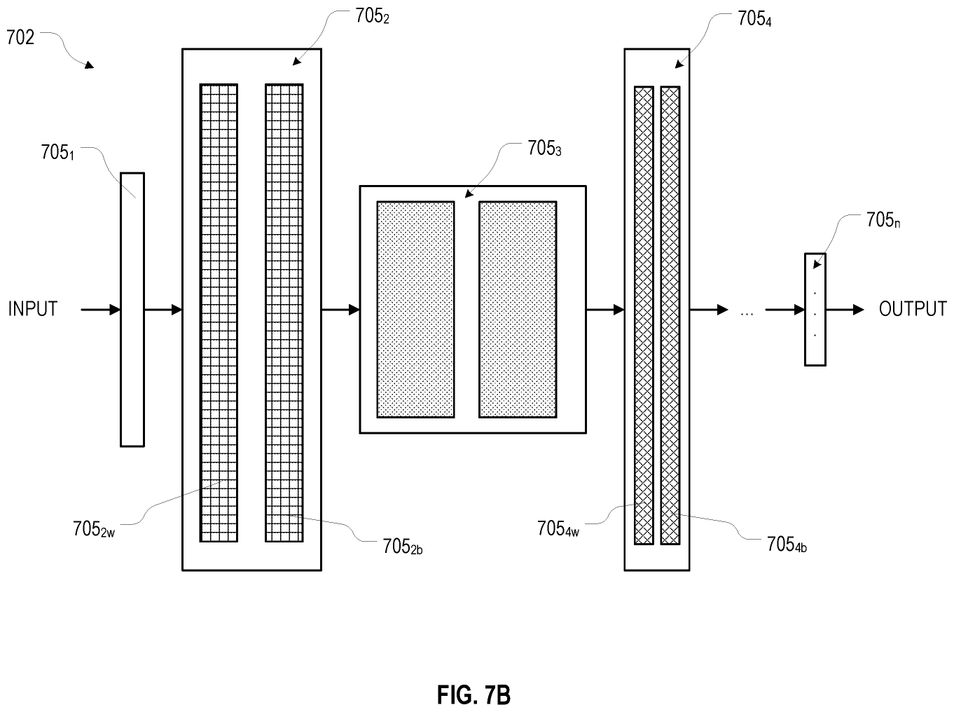

FIG. 7A is an example block diagram 700 of a generative adversarial network (GAN), consistent with some embodiments. As shown in FIG. 7A, the generator AI model, G, may take a vector z, sampled from random Gaussian noise or conditioned with structured input, and may transform the noise to pG-G (z) to mimic the data distribution, pdata. Batches of the

$${J}^{( D )} = - 1 / 2 * ( {E}_{x - pdata} [ log D ( x ) ] ) - 1 / 2 * ( {E}_{z} [ log ( 1 - D ( G ( z ) ) ] ) \qquad ( 1 )$$

$${J}^{( G )} = - 1 / 2 * {E}_{z} [ log D ( G ( z ) ] \qquad ( 2 )$$

generated (fake) images and real images may be sent to the discriminator AI model, D, where the discriminator AI model may assign a label “0” for real or a label “1” for fake. The cost of the discriminator AI model, J(D), and generator AI model, J(G), may respectively be as follows: With an appropriate optimization technique, the neural networks of the generator G AI model and discriminator D AI model may be trained to reach an optimal point. The optimal generator AI model G may produce realistic images and the optimal discriminator AI model D may estimate the likelihood of a given image being real.

The generator AI model and the discriminator AI model in some embodiments may be any software system that recognizes patterns in data sets. In some embodiments, the AI models may comprise a plurality of artificial neurons interconnected through connection points called synapses. Each synapse may encode a strength of the connection between the output of one neuron and the input of another. The output of each neuron, in turn, is determined by the aggregate input received from other neurons that are connected to it, and thus by the outputs of these “upstream” connected neurons and the strength of the connections as determined by the synaptic weights.

The AI models may be trained to solve a specific problem (e.g., discrimination between real and fake images) by adjusting the weights of the synapses such that a particular class of inputs produce a desired output. This weight adjustment procedure in these embodiments is known as “learning.” Ideally, these adjustments lead to a pattern of synaptic weights that, during the learning process, converge toward an optimal solution for the given problem based on some cost function. In some embodiments, the artificial neurons may be organized into layers. FIG. 7B illustrates an example AI model 702, consistent with some embodiments. The AI model 702 in FIG. 7B comprises a plurality of layers 705₁-705ₙ. Each of the layers comprises weights 705_{1w}-705_{nw} and biases 705_{1b}-705_{nb} (only some labeled for clarity). The layer 705₁ that receives external data is the input layer. The layer 705, that produces the ultimate result is the output layer. Some embodiments include a plurality of hidden layers 705₂-705ₙ₋₁ between the input and output layers, and commonly hundreds of such hidden layers. Some of the hidden layers 705₂-705ₙ₋₁ may have different sizes, organizations, and purposes than others of the hidden layers 705₂-705ₙ₋₁. For example, some of the hidden layers in the AI model may be convolution layers, while other hidden layers may be fully connected layers, deconvolution layers, or recurrent layers.

### Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a subsystem, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### GENERAL

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

Therefore, it is desired that the embodiments described herein be considered in all respects as illustrative, not restrictive, and that reference be made to the appended claims for determining the scope of the invention.

What is claimed is:

1. A computer implemented method for resizing a captured image, comprising:
receiving a desired size and a subject of the captured image as input from a user;
automatically resizing the captured image using a generative adversarial network (GAN) to about the desired size, wherein the resizing enhances a prominence of the subject of the captured as compared to the captured image; and
storing the automatically resized image on a computer readable storage medium.

2. The method of claim 1, further comprising analyzing the image using the GAN to identify the subject and one or more other objects in the captured image.

3. The method of claim 2, wherein the analyzing further comprises identifying the subject as a real and the one or more other objects as a fake.

4. The method of claim 3, wherein the enhancing comprises removing objects identified as fake.

5. The method of claim 3, wherein the automatic resizing comprises:
adding additional fake input to the image by a generator component of the GAN; and
removing the additional fake input by a discriminator component of the GAN.

6. The method of claim 3, wherein the analyzing further comprises identifying sensitive information in the captured image as fake.

7. The method of claim 6, wherein the automatic resizing comprises blurring one or more other objects detected as fake.

8. The method of claim 1, further comprising:
generating a higher resolution version of the identified subject using a Super Resolution GAN; and
replacing the identified subject with the generated higher resolution version of the main subject.

9. A system, comprising:
an image sensor;
one or more processors; and
a memory communicatively coupled to the one or more processors;
wherein the memory comprises instructions which, when executed by the one or more processors, cause the one or more processors to perform a method for resizing a captured image, comprising:
receiving a desired size and a subject of the captured image as input from a user;
automatically resizing the captured image using a generative adversarial network (GAN) to about the desired size, wherein the resizing enhances a prominence of the subject of the captured as compared to the captured image; and
storing the automatically resized image on a computer readable storage medium.

10. The system of claim 9, further comprising analyzing the image using the GAN to identify the subject and one or more other objects.

11. The system of claim 10, wherein the analyzing further comprises identifying the subject as a real and the one or more other objects as a fake.

12. The system of claim 11, wherein enhancing the prominence of the subject comprises removing objects identified as fake.

13. The system of claim 11, wherein the automatic resizing comprises:
adding additional fake input to the image by a generator component of the GAN; and
removing the additional fake input by a discriminator component of the GAN.

14. The system of claim 11, wherein the analyzing further comprises identifying sensitive information in the captured image as fake.

15. The system of claim 14, wherein the automatic resizing comprises blurring one or more other objects detected as fake.

16. The system of claim 9, further comprising:
generating a higher resolution version of the identified subject using a Super Resolution GAN; and
replacing the identified subject with the generated higher resolution version of the main subject.

17. A computer program product for resizing a captured image, the computer program product comprising a computer readable storage medium having program instructions embodied therewith, the program instructions executable by a computer system to perform a method for resizing a captured image, comprising:
receiving a desired size and a subject of the captured image as input from a user;
automatically resizing the captured image using a generative adversarial network (GAN) to about the desired size, wherein the resizing enhances a prominence of the subject of the captured as compared to the captured image; and
storing the automatically resized image on the computer readable storage medium.

18. The computer program product of claim 17, further comprising analyzing the image using the GAN to identify the subject and one or more other objects.

19. The computer program product of claim 18, wherein the analyzing further comprises identifying the subject as a real and the one or more other objects as a fake.

20. The computer program product of claim 19, wherein enhancing the prominence of the subject comprises removing objects identified as fake.
